(19) United States
(12) Patent Application Publication
(10) Pub. No.: US 2015/0161333 A1
(43) Pub. Date: Jun. 11, 2015

(54) CLINICAL INFORMATION DISPLAY APPARATUS, METHOD AND PROGRAM

(71) Applicant: FUJIFILM Corporation, Tokyo (JP)

(72) Inventor: Fumitake TANAKA, Ashigarakami-gun (JP)

(73) Assignee: FUJIFILM Corporation, Tokyo (JP)

(21) Appl. No.: 14/561,577

(22) Filed: Dec. 5, 2014

(30) Foreign Application Priority Data
Dec. 9, 2013 (JP) 2013-253902

(51) Int. Cl. G06F 19/00; G06Q 50/24

(52) U.S. Cl. CPC G06F 19/322; G06Q 50/24

(57) ABSTRACT

When pieces of clinical-data registered on registration-dates, respectively, and the registration-dates are stored for each clinical-item, and clinical-data for each of the clinical-items are displayed on a display screen, a latest registration-date or a date on which the clinical-data are displayed on the display screen is set, as an initial-display-base-date, and initial display of the clinical-data is performed. A user's input of selecting one of the registration-dates is received, and the selected-registration-date is set, as a selected-display-base-date. A rank corresponding to a degree of abnormality is given to each of the pieces of clinical-data registered on the selected-display-base-date. Clinical-data for each of the clinical-items registered on registration-dates including the selected-display-base-date are displayed on the display screen by arranging the clinical items in descending order of the degrees of abnormality corresponding to the ranks given to the pieces of clinical data registered on the selected-display-base-date.

### CROSS-REFERENCE TO RELATED APPLICATIONS

The present application claims priority under 35 U.S.C. §119 to Japanese Patent Application No. 2013-253902, filed on Dec. 9, 2013. The above application is hereby expressly incorporated by reference, in its entirety, into the present application.

### BACKGROUND OF THE INVENTION

1. Field of the Invention

The present invention relates to a clinical information display apparatus, method and program for displaying clinical data of plural clinical items.

2. Description of the Related Art

In medical fields, processing is performed to display, on a display device, plural kinds of clinical information, such as results of examination performed on a patient, as reference information for diagnosing a disease name or deciding a treatment policy. Various kinds of examination are performed on a patient. Therefore, in actual medical scenes, there is a request to more efficiently recognize clinical data of a predetermined clinical item to which attention should be paid in diagnosing a specific disease when a patient is suspected of having the specific disease.

Therefore, for example, Japanese Unexamined Patent Publication No. 3(1991)-147067 (Patent Document 1), Japanese Unexamined Patent Publication No. 2009-110282 (Patent Document 2) and Japanese Unexamined Patent Publication No. 2010-176529 (Patent Document 3) disclose techniques for displaying, in an easily recognizable manner, clinical information to which attention should be paid by displaying the clinical information in descending order of the degree of abnormality.

### SUMMARY OF THE INVENTION

However, in the clinical information display apparatuses according to the related art, when the order of display of clinical items is once determined based on clinical information on a base date (ordinarily, a latest registration date of clinical data) that has been initially given, even if a different date to which attention is paid is selected later, the order of display of the clinical items is maintained. Therefore, there is a problem that a long time is required to refer to clinical information on the date to which attention is paid. Further, there is a risk of failure to notice important clinical information which should be referred to in diagnosis.

In view of the foregoing circumstances, it is an object of the present invention to provide a clinical information display apparatus, method and program that can display clinical information to be referred to so that the clinical information is quickly and efficiently referable.

A clinical information display apparatus of the present invention includes a storage unit storing, for each of plural clinical items, plural pieces of clinical data registered on plural registration dates, respectively, and the plural registration dates, and displays clinical data for each of the plural clinical items on a display screen. The clinical information display apparatus includes a base date initial setting unit that sets, as an initial display base date, a latest one of plural registration dates of plural pieces of clinical data or a date on which the clinical data are displayed on the display screen, a base date resetting unit that receives a user's input of selecting one of plural registration dates of plural pieces of clinical data, and sets the selected one of the plural registration dates, as a selected display base date, a ranking unit that gives a rank corresponding to a degree of abnormality to each of plural pieces of clinical data registered on the selected display base date, and a display control unit that sorts and displays the clinical data for each of plural clinical items that have been registered on plural registration dates including the selected display base date on the display screen by arranging the plural clinical items in descending order of the degrees of abnormality corresponding to the ranks given to the plural pieces of clinical data registered on the selected display base date, every time the selected display base date has been set by the base date resetting unit.

Here, the registration date selected by the user may be one day or consecutive plural days. For example, when consecutive plural days are selected by an input by the user, the selected consecutive plural days are set as the selected display base date.

Further, the term “clinical data” means a wide variety of medical data obtained to perform diagnosis and treatment on a patient. Examples of the clinical data are examination data, such as information about examination on a sample and image examination information, treatment data, such as drug administration information, diagnosis data, such as an electronic medical chart and a hospital discharge summary in which doctors recorded information about diagnosis, such as a diagnosis, a symptom and a surgical treatment on a patient to be displayed, and patient's biological data, such as body temperature, blood pressure and a respiratory rate of the patient to be displayed.

Further, the term “registration date of a piece of clinical data” means a predetermined date that has been arbitrarily set for each clinical item, such as a date on which the clinical data have been obtained or a date that can be substantially regarded as a date on which the clinical data have been obtained. For example, a date on which clinical data were input or obtained first or a date on which clinical data were updated last may be regarded as the registration date of the clinical data. For example, when the clinical data are image examination data, a date on which an image was imaged may be regarded as the registration date of the clinical data. When the clinical data are data about examination on a sample, a date on which examination on the sample was performed may be regarded as the registration date of the clinical data. When the clinical data are an electronic medical chart, a date on which the electronic medical chart was prepared or a date on which the electronic medical chart was updated last may be regarded as the registration date of the clinical data. When the clinical data are data representing drug administration information, a date on which a drug was administered may be regarded as the registration date of the clinical data. When the clinical data are biological data, a date on which biological information was measured may be regarded as the registration date of the clinical data.

In the clinical information display apparatus of the present invention, the ranking unit may give a rank corresponding to a degree of abnormality to each of plural pieces of clinical data registered on the initial display base date. Further, the display control unit may display the clinical data for each of plural clinical items that have been registered on plural registration dates including the initial display base date on the display screen by arranging the plural clinical items in descending order of the degrees of abnormality corresponding to the ranks given to the plural pieces of clinical data registered on the initial display base date, in response to setting of the initial display base date by the base date initial setting unit.

Further, in the clinical information display apparatus of the present invention, when the display control unit sorts and displays the clinical data for each of plural clinical items on the display screen by arranging the plural clinical items in descending order of the degrees of abnormality corresponding to the ranks given to the plural pieces of clinical data registered on the selected display base date, in response to setting of the selected display base date by the base date initial setting unit, the display control unit may display clinical data of plural clinical items with a same rank given to clinical data registered on the selected display base date by arranging the plural clinical items in descending order of the degrees of abnormality corresponding to the ranks given to the plural pieces of clinical data registered on the initial display base date.

Further, in the clinical information display apparatus, when the display control unit sorts and displays the clinical data for each of plural clinical items on the display screen by arranging the plural clinical items in descending order of the degrees of abnormality corresponding to the ranks given to the plural pieces of clinical data registered on the selected display base date, in response to setting of the selected display base date by the base date initial setting unit, the display control unit may display the clinical data in such a manner that each of the ranks given to clinical data registered on the initial display base date and the ranks given to clinical data registered on the selected display base date is visually recognizable.

Here, the display control unit may display only the rank given to a piece of clinical data registered on the initial display base date, or only the rank given to a piece of clinical data registered on the selected display base data, instead of displaying both of the rank given to the piece of clinical data registered on the initial display base date and the rank given to the piece of clinical data registered on the selected display base data. Further, it is not always necessary that the display control unit displays ranks for all of the clinical items. The display control unit may display ranks only for a major part of clinical items to which the ranks have been given, and omit display of ranks for the other clinical items.

Here, the expression “display in such a manner that each of the ranks given to clinical data is visually recognizable” includes a wide variety of display mode in which a user who has seen the display can recognize the rank given to a piece of clinical data, such as a mode of displaying a letter, sign or mark representing the rank in a display field displaying the piece of clinical data or a mode of changing the color of a background in the display field displaying the piece of clinical data. When both of the rank given to the piece of clinical data registered on the initial display base date and the rank given to the piece of clinical data registered on the selected display base data are displayed, as described above, for example, a letter, sign or the like representing the rank given to the piece of clinical data on the initial display base date may be displayed in a display field displaying the name of a clinical item, and a letter, sign or the like representing the rank given to the piece of clinical data on the selected display base date may be displayed in a display field displaying the piece of clinical data on the registration date of the piece of clinical data. Accordingly, it is possible to display each of the ranks in a visually recognizable manner.

In the clinical information display apparatus of the present invention, the ranking unit may give a rank corresponding to a degree of abnormality to each of at least all pieces of clinical data to be displayed on the display screen. Further, the display control unit may display all the pieces of clinical data in such a manner that the ranks given to all the pieces of clinical data are visually recognizable.

In the clinical information display apparatus of the present invention, the ranking unit may give a rank to each piece of clinical data belonging to at least a part of plural clinical items, based on clinical data that belong to the same clinical item as the each piece of clinical data and have been registered within a predetermined period before or after the registration date of the each piece of clinical data.

Further, in the clinical information display apparatus of the present invention, when the display control unit displays the each piece of clinical data belonging to at least the part of plural clinical items on the display screen, the display control unit may display the each piece of clinical data in such a manner that the predetermined period based on the selected display base date is visually recognizable in addition to the rank given to the one piece of clinical data registered on the selected display base date.

Here, the expression “display in such a manner that the predetermined period based on the selected display base date is visually recognizable” includes a wide variety of display mode in which a user who has seen the display can recognize the predetermined period based on the selected display base date, such as a mode of changing the color of backgrounds in display fields displaying pieces of clinical data in the predetermined period from the color of backgrounds in display fields displaying the other pieces of clinical data, or a mode of displaying a frame enclosing the display fields displaying the pieces of clinical data in the predetermined period.

In the clinical information display apparatus of the present invention, the ranking unit may give a rank about a clinical item, based on a piece of clinical data of the clinical item registered on a registration date closest to a registration date of a piece of clinical data to which the rank is to be given, when no clinical data registered on the registration date on which the rank is to be given is present.

A clinical information display method is performed by a clinical information display apparatus that includes a storage unit storing, for each of plural clinical items, plural pieces of clinical data registered on plural registration dates, respectively, and the plural registration dates, and displays clinical data for each of the plural clinical items on a display screen. The clinical information display apparatus comprises a base date initial setting unit, a ranking unit, a display control unit, and a base date resetting unit. The clinical information display method comprises a first step in which the base date initial setting unit sets, as an initial display base date, a latest one of plural registration dates of plural pieces of clinical data or a date on which the clinical data are displayed on the display screen, a second step in which the ranking unit gives a rank corresponding to a degree of abnormality to each of plural pieces of clinical data registered on the initial display base date, a third step in which the display control unit displays the clinical data for each of plural clinical items that have been registered on plural registration dates including the initial display base date on the display screen by arranging the plural clinical items in descending order of the degrees of abnormality corresponding to the ranks given to the plural pieces of clinical data registered on the initial display base date, a fourth step in which the base date resetting unit receives a user's input of selecting one of plural registration dates of plural pieces of clinical data, and sets the selected one of the plural registration dates, as a selected display base date, a fifth step in which the ranking unit gives a rank corresponding to a degree of abnormality to each of plural pieces of clinical data registered on the selected display base date, and a sixth step in which the display control unit sorts and displays the clinical data for each of plural clinical items that have been registered on plural registration dates including the selected display base date on the display screen by arranging the plural clinical items in descending order of the degrees of abnormality corresponding to the ranks given to the plural pieces of clinical data registered on the selected display base date.

A clinical information display program of the present invention causes a computer to function as each unit of the clinical information display apparatus of the present invention. The program is recorded on a recording medium, such as a CD-ROM and a DVD, or recorded in a storage attached to a server computer or in a network storage in a downloadable manner, and provided for users.

According to the clinical information display apparatus, method and program of the present invention, when plural pieces of clinical data registered on plural registration dates, respectively, and the plural registration dates are stored for each of plural clinical items, and clinical data for each of the plural clinical items are displayed on a display screen, a latest one of the plural registration dates of the plural pieces of clinical data or a date on which the clinical data are displayed on the display screen is set as an initial display base date, and initial display of the clinical data is performed. Further, a user's input of selecting one of the plural registration dates of the plural pieces of clinical data is received, and the selected one of the plural registration dates is set as a selected display base date. Further, a rank corresponding to a degree of abnormality is given to each of plural pieces of clinical data registered on the selected display base date, and the clinical data for each of plural clinical items that have been registered on plural registration dates including the selected display base date are sorted and displayed on the display screen by arranging the plural clinical items in descending order of the degrees of abnormality corresponding to the ranks given to the plural pieces of clinical data registered on the selected display base date. In other words, after the order of display of clinical items is determined based on clinical data of the initially given display base date and the clinical data are displayed, when a different date to which attention is paid is newly selected, the order of display of clinical items is determined again based on clinical data of the selected date, to which attention is paid, and the display is sorted. Therefore, it is possible to provide display for a user so that the user can quickly and efficiently refer to clinical information to be referred to, which was registered on a date to which attention is paid.

Note that the program of the present invention may be provided being recorded on a computer readable medium. Those who are skilled in the art would know that computer readable media are not limited to any specific type of device, and include, but are not limited to: floppy disks, CD's, RAM's, ROM's, hard disks, magnetic tapes, and internet downloads, in which computer instructions can be stored and/or transmitted. Transmission of the computer instructions through a network or through wireless transmission means is also within the scope of this invention. Additionally, computer instructions include, but are not limited to: source, object and executable code, and can be in any language including higher level languages, assembly language, and machine language.

### BRIEF DESCRIPTION OF THE DRAWINGS

FIG. 1 is a schematic diagram illustrating the configuration of a medical information system to which a clinical information display apparatus of the present invention has been applied;

FIG. 2 is a diagram illustrating an example of an initial display screen displayed by a display control unit:

FIG. 3 is a diagram illustrating an example of a display screen displayed by the display control unit; and

FIG. 4 is a flowchart for explaining the action of the clinical information display apparatus.

### DESCRIPTION OF THE PREFERRED EMBODIMENTS

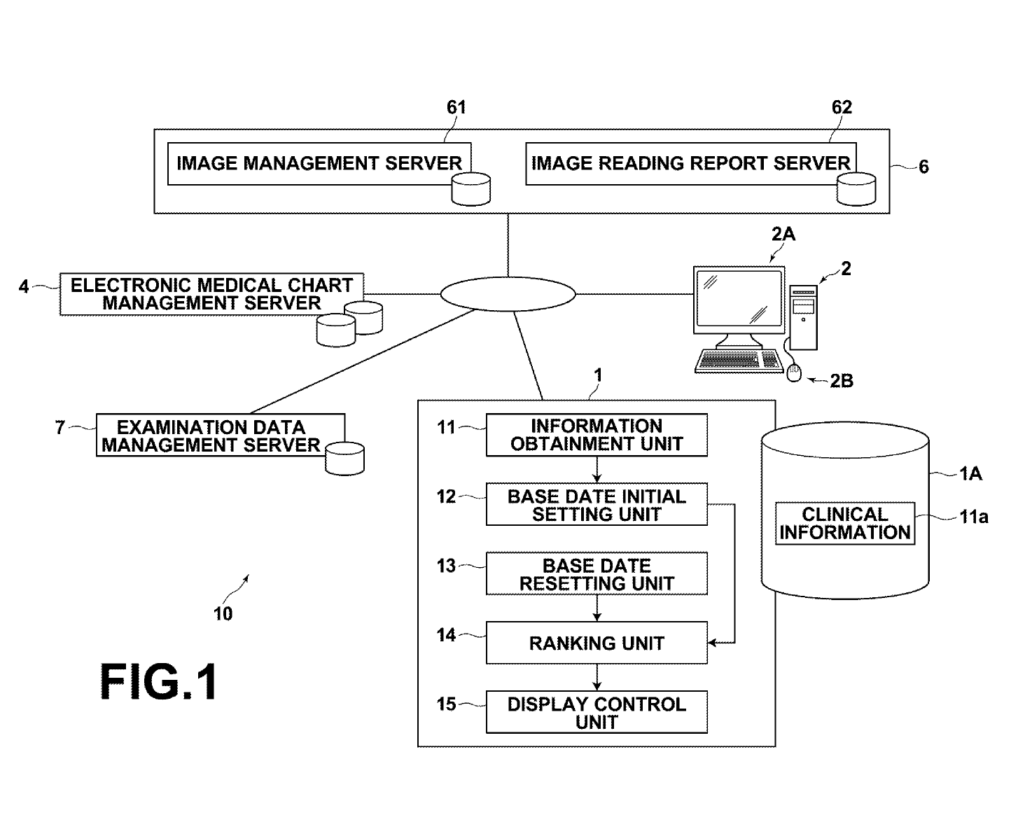

Hereinafter, a medical information system to which a clinical information display apparatus according to an embodiment of the present invention has been applied will be described. FIG. 1 is a schematic diagram illustrating the configuration of this medical information system 10, and which is a functional block diagram of a clinical information display apparatus 1.

As illustrated in FIG. 1, the medical information system 10 is configured by connecting a clinical information display apparatus 1, a clinical department terminal 2, an electronic medical chart management server 4, an image diagnosis system 6 and an examination data management server 7 through a network in such a manner that they can communicate with each other.

The electronic medical chart management server 4 is a computer including an electronic medical chart database in which electronic medical charts are stored. In the computer, software for retrieving, based on a request at the clinical department terminal 2 or the like, an image related to each electronic medical chart and clinical data, such as an examination result, and sending and receiving the result of retrieval has been installed in addition to an operating system and software for managing the database. The electronic medical chart management server 4 is connected to the clinical information display apparatus 1, the clinical department terminal 2, the examination data management server 7, the image diagnosis system 6 and the like through a network in such a manner to be able to obtain each clinical data related to the electronic medical charts.

The examination data management server 7 is a computer including an examination data management database in which examination data are stored. In the computer, software for managing the examination data has been installed in addition to standard software, such as an operation system. An examination date of examination on a sample performed in an examination room based on an examination order input at each clinical department terminal 2 and a result of the examination are input at an examination room terminal placed in each examination room in such a manner to be related to the examination order and a patient's ID, and stored in the examination data management database through a network.

The image diagnosis system 6 is a known computer system. Here, the system is configured by connecting, through a network, a workstation for a doctor in charge of image-based diagnosis, modalities, such as a CT and an MRI, an image management server 61 including an image database and an image reading report server 62 including an image reading report database in such a manner that they can communicate with each other. The image database stores image data obtained by imaging by the modalities, such as a CT and an MRI, and the image reading report database stores image reading reports including results of image reading on the images obtained by imaging. The workstation for a doctor in charge of image-based diagnosis is configured by installing various kinds of image analysis processing software in such a manner that various kinds of image analysis processing are performable based on a purpose of diagnosis and a target of diagnosis.

The clinical department terminal 2 is a computer used by a doctor in a clinical department or the like to retrieve patient's clinical information and to input an examination order or the like. The clinical department terminal 2 includes a display unit 2A, which is a general display, and an input unit 2B including a keyboard and a mouse. The clinical department terminal 2 is used also to display and refer to clinical information, such as a result of an examination performed at each clinical department and a generated electronic medical chart. Standard software, such as an operation system, and application software for displaying clinical information, such as a generated electronic medical chart, have been installed in the clinical department terminal 2.

In an embodiment of the present invention, when the clinical department terminal 2 receives an operation of instruction for starting display of clinical information and an operation of selecting (or inputting) necessary information, such as a patient's ID, by a user, such as a doctor, using the input unit 2B, the clinical department terminal 2 sends various instructions for displaying clinical information and, if necessary, data corresponding to the various instructions to the clinical information display apparatus 1, which will be described later. The clinical information display apparatus 1 receives these various instructions and, if necessary, corresponding data, and sends information necessary to display clinical information to the clinical department terminal 2. Then, the clinical department terminal 2 receives the sent information, and displays, based on the received information, a clinical information display screen, which will be described later, on the display screen of the display unit 2A.

The clinical information display apparatus 1 is a computer including clinical information management database 1A (a storage unit). An operating system and software for managing the database have been installed in the clinical information display apparatus 1. The clinical information display apparatus 1 has also a function as a server for managing clinical information. The clinical information display apparatus 1 is connected, through a network, to the electronic medical chart management server 4, the clinical department terminal 2, the examination data management server 7, the image management server 61 and the image reading report server 62. The clinical information display apparatus 1 obtains clinical information 11a, such as an electronic medical chart of the patient, various kinds of examination data, image data and an image reading report, by retrieving them, based on a patient's ID, from each of the servers or the like connected to the clinical information display apparatus 1. Further, the clinical information display apparatus 1 stores the obtained clinical information 11a in clinical information management database 1A in such a manner to be related to each patient's ID. Accordingly, clinical information management database 1A (a storage unit) records (stores), for plural clinical items included in the clinical information 11a about a target patient, plural pieces of clinical data registered on plural registration dates, respectively, and the registration dates of the plural pieces of clinical data. The clinical information display apparatus 1 updates managed clinical information every day at fixed time. Besides, the clinical information display apparatus 1 updates clinical information, based on a request by each of the aforementioned servers or the like, by receiving pieces of clinical information appropriately sent from each of the servers or the like. Further, the clinical information display apparatus 1 updates clinical information, based on its own need, by appropriately obtaining pieces of clinical information from each of the servers or the like.

In the clinical information display apparatus 1, a clinical information display program according to an embodiment of the present invention has been installed. When the clinical information display program is executed, the clinical information display apparatus 1 functions as an information obtainment unit 11, a base date initial setting unit 12, a base date resetting unit 13, a ranking unit 14, and a display control unit 15. The information obtainment unit 11 obtains and stores, for each of plural clinical items, plural pieces of clinical data about a target patient that have been registered on plural registration dates, respectively, and the plural registration dates in clinical information management database 1A. The base date initial setting unit 12 sets, as an initial display base date, in other words, as an initial value of the display base date, a latest one of the registration dates of the pieces of clinical data or a date on which the clinical data are to be displayed on the display screen (today). The base date resetting unit 13 receives a user's input of selecting one of the registration dates of the pieces of clinical data, and sets the selected registration date, as a selected display base date, in other words, as a new display base date. The ranking unit 14 gives a rank corresponding to a degree of abnormality to each of the plural pieces of clinical data registered on the selected display base date. The display control unit 15 sorts and displays the clinical data for each of the clinical items that have been registered on plural registration dates including the selected display base date on the display screen by arranging the plural clinical items in descending order of the degrees of abnormality corresponding to the ranks given to the plural pieces of clinical data registered on the selected display base date, every time the display base date has been set.

For example, when the clinical department terminal 2 receives an operation of instruction for starting display of clinical information and an operation of inputting necessary information, such as a patient's ID, by a user, the information obtainment unit 11 obtains clinical information about the patient by retrieving, based on the input patient's ID, the clinical information from the electronic medical chart management server 4, the examination data management server 7, the image management server 61 and the image reading report server 62. The information obtainment unit 11 stores the obtained clinical information in clinical information management database 1A.

Further, the base date initial setting unit 12 sets, as an initial display base date, a latest one of registration dates of plural pieces of clinical data included in clinical information 11a about the patient (or a date on which the clinical data are to be displayed on the display screen) by referring to the clinical information 11a about the patient stored in clinical information management database 1A. Further, the ranking unit 14 gives a rank corresponding to a degree of abnormality to each of plural pieces of clinical data registered on the initial display base date. For example, the ranking unit 14 evaluates a degree of abnormality for each of the pieces of clinical data, and gives one of rank A (an abnormal value), rank B (close to the abnormal value) and rank C (others) based on the result of evaluation to each of the pieces of clinical data. Needless to say, the ranks may be defined by further being divided into smaller groups of levels.

At this time, an evaluation criterion for evaluating the degree of abnormality corresponding to the content of each clinical item is prepared in advance for each of the clinical items. The ranking unit 14 gives a rank to each of the pieces of clinical data by evaluating the degree of abnormality based on an evaluation criterion related to a clinical item to which the piece of clinical data belongs. For some clinical items, the ranking unit 14 may give a rank based on clinical data that belong to the same clinical item as the piece of clinical data to which the rank is to be given and have been registered within a predetermined period before or after the registration date of the piece of clinical data to which the rank is to be given.

Further, when no clinical data registered on the registration date on which a rank is to be given is present in a target clinical item, the ranking unit 14 may give a rank based on a piece of clinical data registered on a registration date closest to a registration date on which the rank is to be given. Alternatively, a rank with a lowest degree of abnormality may be given. In this case, a rank representing that the rank is unknown is set in advance, as a rank with a lowest degree of abnormality.

Next, the display control unit 15 generates and displays a clinical information display screen based on the obtained clinical information about the patient who is a target of display of clinical information. The display control unit 15 sorts and displays the clinical data for each of the plural clinical items that have been registered on plural registration dates including the initial display base date on the display screen by arranging the plural clinical items in descending order of the degrees of abnormality corresponding to the ranks given by the ranking unit 14 to the plural pieces of clinical data registered on the initial display base date. Human eyes ordinarily move from left to right, and from top to bottom. Therefore, when clinical data of plural clinical items are arranged in an up-down direction and displayed, the display control unit 15 displays a clinical item with a higher rank corresponding to the degree of abnormality at a higher position. When plural clinical items are arranged in a left-right direction and displayed, the display control unit 15 displays a clinical item with a higher rank corresponding to the degree of abnormality closer to the left side.

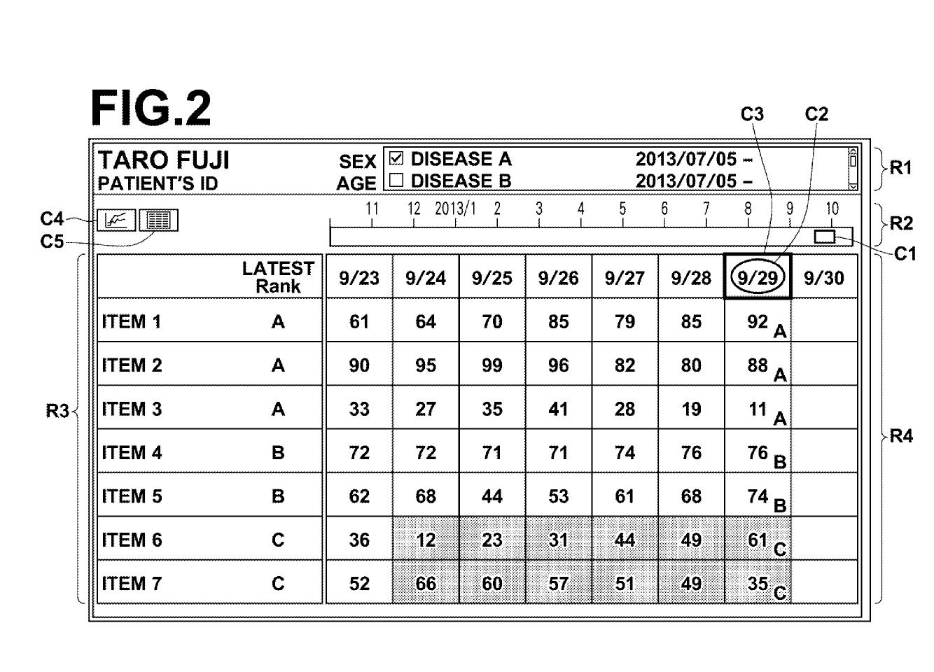

FIG. 2 is a diagram illustrating an example of an initial display screen displayed on the clinical department terminal 2 by control by the display control unit 15. As illustrated in FIG. 2, basic information display field R1, examination period display field R2, clinical item display field R3 and clinical data display field R4 are provided in the display screen. In basic information display field R1, basic information about a patient, such as a name, ID, age, sex and disease, is displayed. Regarding diseases, a check box is displayed for each of the diseases. A disease to which attention is paid is selected by checking the check box, and clinical data of only plural clinical items that have been related, in advance, to the disease to which attention is paid are displayed on the display screen.

In examination period display field R2, a period in which clinical data of the patient are present is displayed by a time line. Further, rectangular index C1 is displayed at a position in examination period display field R2 corresponding a period of detailed display in which detailed clinical data are displayed in clinical data display field R4. In clinical item display field R3, the item name of each clinical item to be displayed is displayed. Further, clinical data display field R4 is provided next to clinical item display field R3. In clinical data display field R4, clinical data corresponding to each clinical item displayed in clinical item display field R3 are displayed, based on the registration date of the clinical data, for each of the clinical items.

Further, as illustrated in FIG. 2, in clinical data display field R4, circular line C2 is displayed around a date corresponding to a latest registration date (September 29) of clinical data, and frame line C3 is displayed in a cell of a date corresponding to a registration date (September 29) set as an initial display base date. Further, in a cell displaying each piece of clinical data on the initial display base date, a rank given to the piece of clinical data is displayed. Further, a rank given to the piece of clinical data on the initial display base date is displayed also in a cell of each clinical item name in clinical item display field R3. In the display screen illustrated in FIG. 2, the ranking unit 14 has given rank A (an abnormal value) to clinical data of clinical items 1 through 3, rank B (close to the abnormal value) to clinical data of clinical items 4 and 5, and rank C (a tendency of increase or decrease for five days) to clinical data of clinical items 6 and 7. FIG. 2 illustrates a case in which the display control unit 15 sorts and displays clinical data of clinical items 1 through 7 in the order of ranks A, B and C.

As illustrated in FIG. 2, in clinical items 6 and 7, the ranking unit 14 gives a rank based on clinical data that belong to the same clinical item as the clinical data to which the rank is to be given and have been registered within a predetermined period before or after the registration date of the clinical data to which the rank is to be given. Regarding clinical items 6 and 7, a color different from the color of the other cells is given to cells displaying clinical data within a predetermined period (September 24 through September 29), which was used in giving the rank, in addition to display of the given rank.

In the display screen illustrated in FIG. 2, display of clinical data in clinical data display field R4 is switchable between a table format and a graph format. When graph format display button C4 at an upper left section of the display screen is selected, graph format display is applied. When table format display button C5 at the upper left section of the clinical information display screen is selected, table format display is applied.

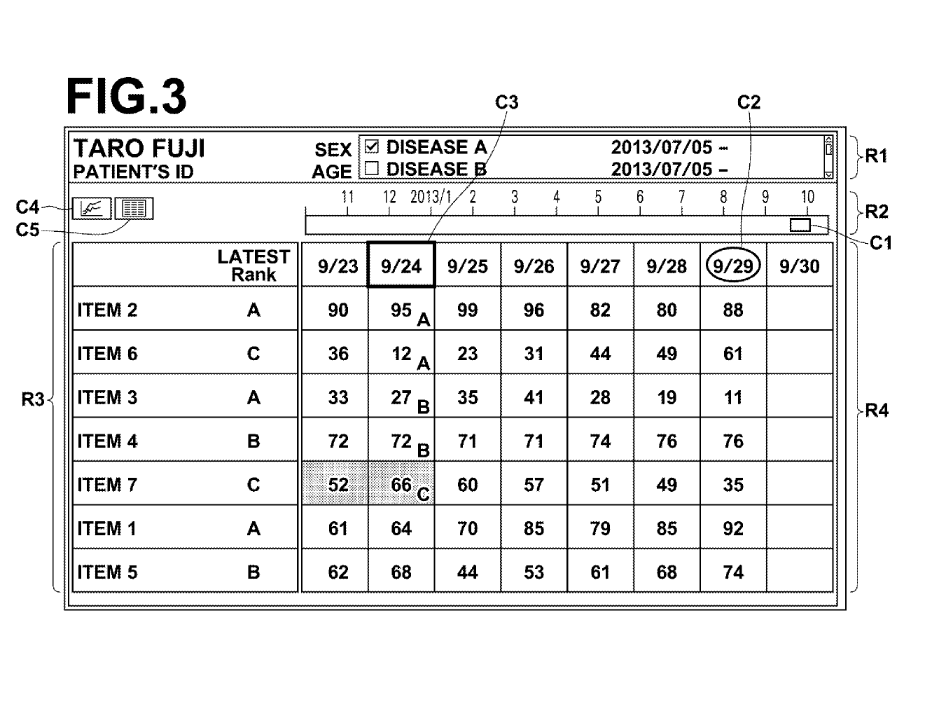

After the initial display screen is displayed, as described above, when a user's input operation of selecting a different date dates to which attention is paid is received at the clinical department terminal 2, the base date resetting unit 13 sets the selected date, as a selected display base date. Then, the ranking unit 14 gives ranks according to the degrees of abnormality to plural pieces of clinical data registered on the selected display base date, respectively. Further, the display control unit 15 updates the display screen based on a change in the display base date and a change in ranking. FIG. 3 is a diagram illustrating an example of a display screen after update when September 24 has been selected by the user, as a date to which attention is paid, in the display screen illustrated in FIG. 2.

As illustrated in FIG. 3, in the display screen after update, frame line C3 is moved to a cell of a date corresponding to the selected display base date (September 24). Further, a rank given to each piece of clinical data on the selected display base date (September 24) is displayed in a cell displaying the piece of clinical data. Further, display of clinical data for each clinical item is sorted by arranging the plural clinical items in descending order of the degrees of abnormality corresponding to the ranks given to the plural pieces of clinical data registered on the selected display base date. In the display screen illustrated in FIG. 3, the ranking unit 14 has given rank A (an abnormal value) to clinical data of clinical items 2 and 6, rank B (close to the abnormal value) to clinical items 3 and 4, and rank C (a tendency of increase or decrease for five days) to clinical item 7. FIG. 3 illustrates a case in which the display control unit 15 sorts and displays clinical data of clinical items 1 through 7 in the order of ranks A, B and C.

At this time, as illustrated in FIG. 3, pieces of clinical data of plural clinical items with a same rank given to pieces of clinical data registered on the selected display base date are sorted and displayed by arranging the plural clinical items in descending order of the degrees of abnormality corresponding to the ranks given to the plural pieces of clinical data registered on the initial display base date. In medical treatment, a latest condition is important. Therefore, when clinical data are displayed in this manner, it is possible to prevent failure to notice important clinical data while checking a relationship between past clinical data and current clinical data. Further, as illustrated in FIG. 3, besides a rank on the selected registration date (September 24), a rank on the latest registration date (September 29) is displayed at the same time. Therefore, it is possible to further prevent failure to notice important clinical data.

Further, in some clinical items, clinical data with a predetermined tendency of increase or decrease are judged as rank A even if the clinical data do not have an abnormal value. When judgment is made based on a tendency in this manner, a rank is evaluated by using clinical data within a predetermined period before or after the display base date when the display base date has been set. The predetermined period is a set value that has been set in advance.

With respect to a display base date, both of evaluation as to the display base date alone and evaluation as to a predetermined period before or after the display base date may be performed. For example, comprehensive evaluation is made by obtaining an average of the evaluation result as to the display base date alone and the evaluation result as to the predetermined period. Consequently, it is possible to more easily find an abnormal condition.

In FIG. 3, only the ranks on September 24 and the latest ranks on September 29 are displayed on the display screen. However, the display is not limited to this example, and ranks for clinical data on all of the registration dates may be displayed. As FIG. 3 shows, when numerical values are simply listed, it is difficult to quickly recognize an abnormal value because a range from a lower limit to an upper limit and a range of fluctuation of clinical data are wide. Further, depending on the content of examination, large values indicate an abnormal condition in some clinical items, and small values indicate an abnormal condition in some other clinical items, and such values are mixed. Therefore, it is impossible to quickly judge an abnormal condition. However, when ranges are narrowed and the criteria for judging an abnormal condition are unified as in ranks A, B and C, it is possible to immediately recognize, for example, rank A with a highest degree of abnormality. When such ranks are displayed for all of the registration dates so that the whole data are broadly observable, it is possible to easily recognize a tendency of abnormality, and to easily find a problem. Specifically, the criteria for judging abnormality were multidimensional, and the abnormality was judged based on whether a value is large, whether a value is small, whether there is a tendency of increase, whether there is a tendency of decrease, or the like. However, the criteria have been unified to a one-dimensional criterion, such as the evaluated ranks, and data based on the one-dimensional criterion are displayed through plural registration dates so that the whole data are broadly observable. That can greatly improve the efficiency of diagnosis. This advantageous effect would not be achievable even if graph format display is adopted. Adoption of table format display has a significant meaning.

Here, a case in which a period of detailed display, in which detailed clinical data are displayed in clinical data display field R4, in the initial display screen is maintained also in the updated display screen is illustrated. The period of detailed display is appropriately changed based on the date selected by the user or a manner of setting the period of detailed display.

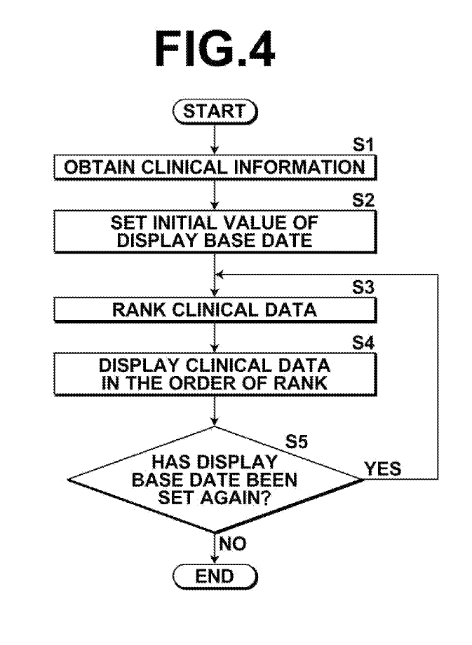

Next, the action of the medical information system 10 will be described with reference to a flowchart illustrated in FIG. 4. The medical information system 1 according to an embodiment of the present invention has characteristic features in display of clinical information. Therefore, such features will be mainly described. First, a user's input of an instruction to start display of clinical information by specifying a patient's ID of a target patient is received at the clinical department terminal 2. Then, the information obtainment unit 11 collects clinical information 11a about the patient based on the input patient's ID, and stores the collected clinical information 11a in clinical information management database 1A (S1). Then, first, the base date initial setting unit 12 refers to clinical information 11a about the patient stored in clinical information management database 1A, sets a latest registration date of clinical data included in the clinical information, as an initial display base date (S2). Then, the ranking unit 14 gives a rank corresponding to a degree of abnormality to each of plural pieces of clinical data registered on a display base date (an initial display base date in the first ranking operation, and a selected display base date in the second ranking operation and later) (S3). The display control unit 15 sorts and displays the clinical data for each of clinical items that have been registered on plural registration dates including the initial display base date on the display screen by arranging the plural clinical items in descending order of the degrees of abnormality corresponding to the ranks given to the plural pieces of clinical data (S4).

After then, whether a user performs, at the clinical department terminal 2, an input operation of selecting a different date to which attention is paid is monitored. When an input operation of selecting a different date to which attention is paid is performed, the base date resetting unit 13 sets the selected registration date, as a selected display base date (S5), and processing in step S3 and later is performed. When a user's input of instruction to end display of clinical information at the clinical department terminal 2 is received, processing ends.

As described above, in the medical information system 10 according to an embodiment of the present invention, the order of display of clinical items is determined based on clinical data on a display base date that has been initially given. After the clinical data are displayed, when a different date to which attention is paid is newly selected, the order of display of clinical items is determined again based on clinical data on the selected date to which attention is paid, and the display is sorted. Therefore, it is possible to provide display for a user so that the user can quickly and efficiently refer to clinical information to be referred to, which was registered on a date to which attention is paid.

In the aforementioned embodiment, a case in which one registration date is selected by a user, as a date to which attention is paid, has been described. The registration date selected by the user may be consecutive plural days. For example, when consecutive plural days are selected by a user's input, the selected consecutive plural days are set as the selected display base date. In this case, the ranking unit 14 obtains degrees of abnormality for respective pieces of clinical data on the selected consecutive plural days, and calculates a representative value, such as an average, a maximum value or a minimum value, of the obtained degrees of abnormality. Further, the ranking unit 14 comprehensively evaluates the degree of abnormality by using the calculated representative value, and performs ranking. When consecutive plural days are used as a display base date in this manner, a user can check the approximate condition of the patient in a period to which attention is paid by displaying clinical information based on the display base date.

In the description of the embodiment with reference to FIG. 2 and FIG. 3, a case in which a latest registration date of clinical data is set as the initial display base date was described. Alternatively, a date on which clinical data are displayed on the display screen may be set as the initial display base date. Specifically, a date on which a user opens a display screen and displays clinical data on the display screen, i.e., a date on which the user uses the clinical data may be set, as the initial display base date. In this case, no clinical data may be present on the initial display base date in some cases. In such cases, a rank corresponding to a degree of abnormality is given to a piece of clinical data on a date closest to the initial display base date, and the order of display of clinical items may be determined based on the given rank. When the clinical items are displayed in this manner, the order of display is not changed from the case of using the latest registration date as the initial value of the display base date. However, since the date on which the clinical data are displayed is displayed in the rightmost column in the display screen illustrated in FIG. 3, diagnosis becomes easy.

In the descriptions of the aforementioned embodiment, ranking is performed by obtaining ranks when a date to which attention is paid has been selected. Alternatively, ranks may be obtained in advance for each of all dates. In this case, when clinical data are read out on a display screen, evaluation of ranks are performed on all of the dates. Further, the evaluated ranks may be stored in DB, and used when clinical data are displayed next time.

The present invention is not limited to the aforementioned embodiments. A part or all of composition elements of the clinical information display apparatus may be configured by a workstation. Alternatively, the clinical information display apparatus may be configured by at least one workstation, a server and a storage device connected to each other through a network. Each equipment is controlled by a program for performing display of clinical information described in the specification of the present application, and which has been installed from a recording medium, such as a CD-ROM. The program may be installed after being downloaded from a storage device of a server connected through a network, such as the Internet.

The aforementioned embodiments represent only one of modes of the present invention. The present invention may be arbitrarily modified and applied without departing from the gist of the present invention.

What is claimed is:

1. A clinical information display apparatus that includes a storage unit storing, for each of a plurality of clinical items, a plurality of pieces of clinical data registered on a plurality of registration dates, respectively, and the plurality of registration dates, and displays clinical data for each of the plurality of clinical items on a display screen, the apparatus comprising:
a base date initial setting unit that sets, as an initial display base date, a latest one of the plurality of registration dates of the plurality of pieces of clinical data or a date on which the clinical data are displayed on the display screen;
a base date resetting unit that receives a user's input of selecting one of the plurality of registration dates of the plurality of pieces of clinical data, and sets the selected one of the plurality of registration dates, as a selected display base date;
a ranking unit that gives a rank corresponding to a degree of abnormality to each of the plurality of pieces of clinical data registered on the selected display base date; and
a display control unit that sorts and displays the clinical data for each of the plurality of clinical items that have been registered on a plurality of registration dates including the selected display base date on the display screen by arranging the plurality of clinical items in descending order of the degrees of abnormality corresponding to the ranks given to the plurality of pieces of clinical data registered on the selected display base date, every time the selected display base date has been set by the base date resetting unit.

2. The clinical information display apparatus, as defined in claim 1, wherein the ranking unit gives a rank corresponding to a degree of abnormality to each of the plurality of pieces of clinical data registered on the initial display base date, and
wherein the display control unit displays the clinical data for each of the plurality of clinical items that have been registered on a plurality of registration dates including the initial display base date on the display screen by arranging the plurality of clinical items in descending order of the degrees of abnormality corresponding to the ranks given to the plurality of pieces of clinical data registered on the initial display base date, in response to setting of the initial display base date by the base date initial setting unit.

3. The clinical information display apparatus, as defined in claim 1, wherein when the display control unit sorts and displays the clinical data for each of the plurality of clinical items on the display screen by arranging the plurality of clinical items in descending order of the degrees of abnormality corresponding to the ranks given to the plurality of pieces of clinical data registered on the selected display base date, in response to setting of the selected display base date by the base date initial setting unit, the display control unit displays clinical data of a plurality of clinical items with a same rank given to clinical data registered on the selected display base date by arranging the plurality of clinical items in descending order of the degrees of abnormality corresponding to the ranks given to the plurality of pieces of clinical data registered on the initial display base date.

4. The clinical information display apparatus, as defined in claim 1, wherein the ranking unit gives a rank corresponding to a degree of abnormality to each of at least all pieces of clinical data to be displayed on the display screen, and
wherein the display control unit displays all the pieces of clinical data in such a manner that the ranks given to all the pieces of clinical data are visually recognizable.

5. The clinical information display apparatus, as defined in claim 1, wherein the ranking unit gives a rank to each piece of clinical data belonging to at least a part of the plurality of clinical items, based on clinical data that belong to the same clinical item as the each piece of clinical data and have been registered within a predetermined period before or after the registration date of the each piece of clinical data.

6. The clinical information display apparatus, as defined in claim 5, wherein when the display control unit displays the each piece of clinical data belonging to at least the part of the plurality of clinical items on the display screen, the display control unit displays the each piece of clinical data in such a manner that the predetermined period based on the selected display base date is visually recognizable in addition to the rank given to the piece of clinical data registered on the selected display base date.

7. The clinical information display apparatus, as defined in claim 1, wherein the ranking unit gives a rank about a clinical item, based on a piece of clinical data of the clinical item registered on a registration date closest to a registration date of a piece of clinical data to which the rank is to be given, when no clinical data registered on the registration date on which the rank is to be given is present.

8. The clinical information display apparatus, as defined in claim 2, wherein when the display control unit sorts and displays the clinical data for each of the plurality of clinical items on the display screen by arranging the plurality of clinical items in descending order of the degrees of abnormality corresponding to the ranks given to the plurality of pieces of clinical data registered on the selected display base date, in response to setting of the selected display base date by the base date initial setting unit, the display control unit displays clinical data of a plurality of clinical items with a same rank given to clinical data registered on the selected display base date by arranging the plurality of clinical items in descending order of the degrees of abnormality corresponding to the ranks given to the plurality of pieces of clinical data registered on the initial display base date.

9. The clinical information display apparatus, as defined in claim 2, wherein when the display control unit sorts and displays the clinical data for each of the plurality of clinical items on the display screen by arranging the plurality of clinical items in descending order of the degrees of abnormality corresponding to the ranks given to the plurality of pieces of clinical data registered on the selected display base date, in response to setting of the selected display base date by the base date initial setting unit, the display control unit displays the clinical data in such a manner that each of the ranks given to clinical data registered on the initial display base date and the ranks given to clinical data registered on the selected display base date is visually recognizable.

10. The clinical information display apparatus, as defined in claim 2, wherein the ranking unit gives a rank corresponding to a degree of abnormality to each of at least all pieces of clinical data to be displayed on the display screen, and
wherein the display control unit displays all the pieces of clinical data in such a manner that the ranks given to all the pieces of clinical data are visually recognizable.

11. The clinical information display apparatus, as defined in claim 2, wherein the ranking unit gives a rank to each piece of clinical data belonging to at least a part of the plurality of clinical items, based on clinical data that belong to the same clinical item as the each piece of clinical data and have been registered within a predetermined period before or after the registration date of the each piece of clinical data.

12. The clinical information display apparatus, as defined in claim 11, wherein when the display control unit displays the each piece of clinical data belonging to at least the part of the plurality of clinical items on the display screen, the display control unit displays the each piece of clinical data in such a manner that the predetermined period based on the selected display base date is visually recognizable in addition to the rank given to the piece of clinical data registered on the selected display base date.

13. The clinical information display apparatus, as defined in claim 2, wherein the ranking unit gives a rank about a clinical item, based on a piece of clinical data of the clinical item registered on a registration date closest to a registration date of a piece of clinical data to which the rank is to be given, when no clinical data registered on the registration date on which the rank is to be given is present.

14. A clinical information display method performed by a clinical information display apparatus that includes a storage unit storing, for each of a plurality of clinical items, a plurality of pieces of clinical data registered on a plurality of registration dates, respectively, and the plurality of registration dates, and displays clinical data for each of the plurality of clinical items on a display screen, the apparatus comprising:
a base date initial setting unit;
a ranking unit;
a display control unit; and
a base date resetting unit, and
the method comprising:
a first step in which the base date initial setting unit sets, as an initial display base date, a latest one of the plurality of registration dates of the plurality of pieces of clinical data or a date on which the clinical data are displayed on the display screen;
a second step in which the ranking unit gives a rank corresponding to a degree of abnormality to each of the plurality of pieces of clinical data registered on the initial display base date;
a third step in which the display control unit displays the clinical data for each of the plurality of clinical items that have been registered on a plurality of registration dates including the initial display base date on the display screen by arranging the plurality of clinical items in descending order of the degrees of abnormality corresponding to the ranks given to the plurality of pieces of clinical data registered on the initial display base date;
a fourth step in which the base date resetting unit receives a user's input of selecting one of the plurality of registration dates of the plurality of pieces of clinical data, and sets the selected one of the plurality of registration dates, as a selected display base date;
a fifth step in which the ranking unit gives a rank corresponding to a degree of abnormality to each of the plurality of pieces of clinical data registered on the selected display base date; and
a sixth step in which the display control unit sorts and displays the clinical data for each of the plurality of clinical items that have been registered on a plurality of registration dates including the selected display base date on the display screen by arranging the plurality of clinical items in descending order of the degrees of abnormality corresponding to the ranks given to the plurality of pieces of clinical data registered on the selected display base date.

15. A non-transitory computer-readable recording medium having stored therein a clinical information display program that causes a computer to store, for each of a plurality of clinical items, a plurality of pieces of clinical data registered on a plurality of registration dates, respectively, and the plurality of registration dates, and to display clinical data for each of the plurality of clinical items on a display screen, the program causing the computer to function as:
a base date initial setting unit that sets, as an initial display base date, a latest one of the plurality of registration dates of the plurality of pieces of clinical data or a date on which the clinical data are displayed on the display screen;
a base date resetting unit that receives a user's input of selecting one of the plurality of registration dates of the plurality of pieces of clinical data, and sets the selected one of the plurality of registration dates, as a selected display base date;
a ranking unit that gives a rank corresponding to a degree of abnormality to each of the plurality of pieces of clinical data registered on the selected display base date; and
a display control unit that sorts and displays the clinical data for each of the plurality of clinical items that have been registered on a plurality of registration dates including the selected display base date on the display screen by arranging the plurality of clinical items in descending order of the degrees of abnormality corresponding to the ranks given to the plurality of pieces of clinical data registered on the selected display base date, every time the selected display base date has been set by the base date resetting unit.

16. The non-transitory computer-readable recording medium, as defined in claim 15, wherein the ranking unit gives a rank corresponding to a degree of abnormality to each of the plurality of pieces of clinical data registered on the initial display base date, and
wherein the display control unit displays the clinical data for each of the plurality of clinical items that have been registered on a plurality of registration dates including the initial display base date on the display screen by arranging the plurality of clinical items in descending order of the degrees of abnormality corresponding to the ranks given to the plurality of pieces of clinical data registered on the initial display base date, in response to setting of the initial display base date by the base date initial setting unit.
